(19) United States
(12) Patent Application Publication
(10) Pub. No.: US 2012/0267406 A1
(43) Pub. Date: Oct. 25, 2012

(54) SUCTION DISC SUPPORT SET WITH AUXILIARY TOOL FOR EMERGENCY ESCAPE

(76) Inventor: Eagle Fan, Hsinchu (TW)

(21) Appl. No.: 13/093,102

(22) Filed: Apr. 25, 2011

(51) Int. Cl. B60R 11/00

(52) U.S. Cl. 224/482

(57) ABSTRACT

A suction disc support set with auxiliary tool for emergency escape is provided, including a suction disc set and a connecting support unit. The suction disc is for attaching to a flat surface. One end of the connecting support unit is connected to the suction disc set, and the other end can be connected to any suitable holding base for holding a portable device. The main body of the present invention is to form at least a sharp conic object in a frame of the connecting support unit. A knife can be further included in the frame. In this manner, the suction disc support set is attached to the windshield when in use, while in emergency, the present invention can be used as a tool to break the glass or cut off the stuck seat belt for escape from inside a car.

### FIELD OF THE INVENTION

The present invention generally relates to a suction disc support set, and more specifically to a suction disc support set able to function as an auxiliary tool to assist driver escape from the vehicle when in emergency.

### BACKGROUND OF THE INVENTION

Car accident could be fatal sometimes. In an accident, the car body may be deformed, the power or electrical system may stop functioning, and the fuel may leak. Unless the driver is unable to move, the driver is advised to escape from the car to avoid fatality, such as car explosion or burning, or even signaling the following cars to prevent further tailing. As the car is closed space, the accident may have door stuck, window unable to roll down, and the driver is trapped inside the car. The driver can try to break the window or windshield to escape, but as the windows and the windshield are usually made of tampered glass, the driver usually find it very difficult to break the glass with bare hand. The safety experts advise the use of sharp and hard object to strike on the area close to the edge of the glass in order to break the tampered glass. However, most cars are not equipped with such a sharp object, and the consequence may reduce the chance of the driver to escape safely. Although some drivers may carry such an object in the car, but in emergence or as the time moves on, the driver may have forgotten where the object is placed or stored inside the car.

The popularity of portable devices, such as GPS and mobile phone, in the car has sprouted a plurality of hand-free apparatuses for holding portable device. A typical hand-free apparatus includes a portable device holder and a suction disc support set. Place placing the portable device inside the holder, and in combination with a suction disc support set, the portable device can be fixed to the flat surface above the dash board. The present invention aims to integrate the aforementioned emergency tool into the design of a portable device holder with a suction disc support set to assist the driver when in emergency.

### SUMMARY OF THE INVENTION

The primary object of the present invention is to provide a suction disc support set able to function as an auxiliary tool for emergency escape. The present invention is mainly to improve the portable device holder that is usually place in a visible and easily accessible place. By adding an exposed cone-shape object or a knife to the structure of the suction disc support set, the suction disc support set can be used as an auxiliary tool to assist the driver to cut the seat belt or break the window and escape from the car during an emergency.

To achieve the above object, the present invention provides a suction disc support set, including a suction disc set and a connecting support unit. The suction disc is for attaching to a flat surface. One end of the connecting support unit is connected to the suction disc set, and the other end can be connected to any suitable holding base for holding a portable device. The main body of the present invention is to form at least a sharp conic object in a frame of the connecting support unit. In this manner, the suction disc support set is attached to the windshield when in use, while in emergency, the present invention can be used as a tool to break the glass for escape.

In addition, the present invention may also include a knife in the frame of the suction disc support set. The blade of the knife can be partially exposed or folded to hide inside the frame. When the seat belt is stuck in the emergency, the knife can be used to cut off the seat belt to release the driver.

The disadvantages of the present invention includes:

1. A multi-function product can add value to the product and gain competitive edge in the market.

2. The suction disc support set is usually attached to the windshield in normal use condition, i.e., at a location visible and easily accessible to the driver. When in emergency, the driver can easily know where and how to access the auxiliary tool integrally designed into the suction disc support set to assist the escape.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a hand-free apparatus having a suction disc support set and a holding base according to the invention;

FIG. 2 shows a schematic view of the present invention;

FIG. 3 shows a schematic view of the detached parts of the present invention;

FIG. 4 shows a schematic view of the present invention in actual application in normal use; and

FIG. 5 shows a schematic view of using the frame of the present invention to hit the glass when in emergency.

### DETAILED DESCRIPTION OF THE PREFERRED EMBODIMENTS

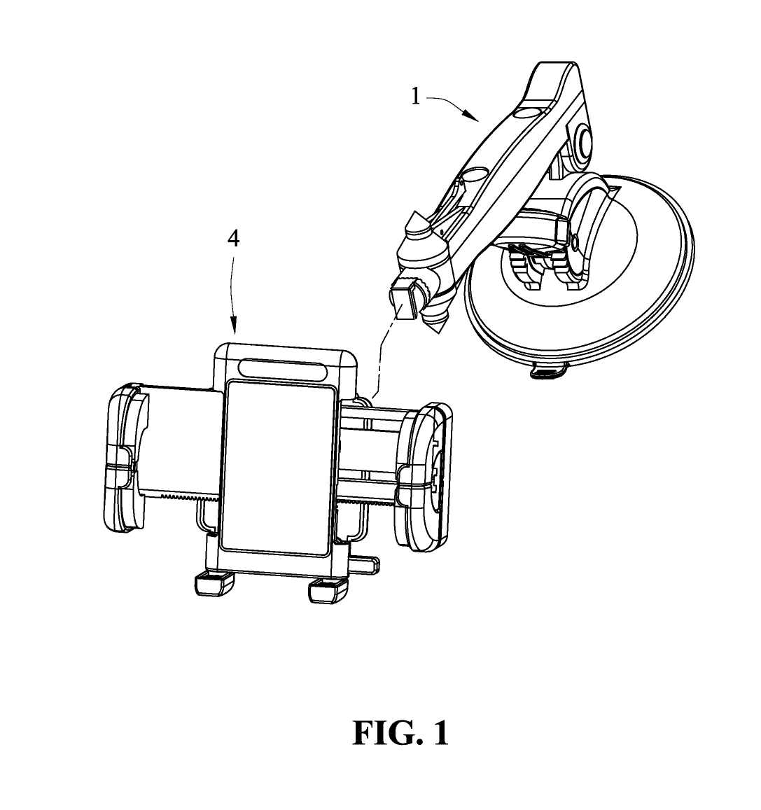

As shown in FIG. 1, a hand-free apparatus usually includes a suction support set 1 and a holding base 4. Holding base 4 is for holding a portable device, such as, mobile phone or GPS. Holding base 4 in the embodiment is only exemplary for illustrative purpose, and is not restricted to any specific type or shape. Suction disc support set 1 is for attaching to the windshield. Holding base 4 can be engaged to suction disc support set 1. The joint of suction disc support set 1 is adjustable so that the placement and the angles of holding base 4 (and the held portable device) can be adjusted for optimal effect. The present invention is to improve the structure of suction disc support set 1 without affecting the basic suction and adjustment function.

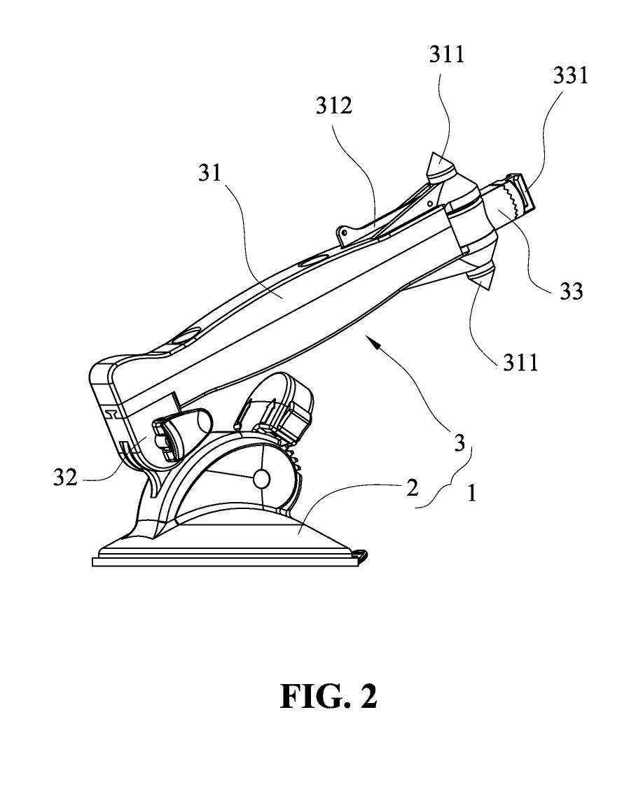

FIG. 2 shows a schematic view of the present invention. Suction disc support set 1 of the present invention includes a suction disc set 2 and a connecting support unit 3. Suction disc set 2 can be used to attach to a flat surface. One end of connecting support unit 3 is coupled to suction disc set 2, and the other end provides engagement to aforementioned holding base 4. The main improvement of the present invention is to form at least a solid metal conic body 311 at frame 31 of connecting support unit 3. Frame 31 can be used as a hammer to break the window with solid metal conic body 311 in an emergency. In addition, a knife 312 can be placed at other locations of frame 31. The blade of knife 312 can be folded into and hidden inside frame 31. When opened, a small part of the blade is exposed to cut off stuck seat belt to assist the escape.

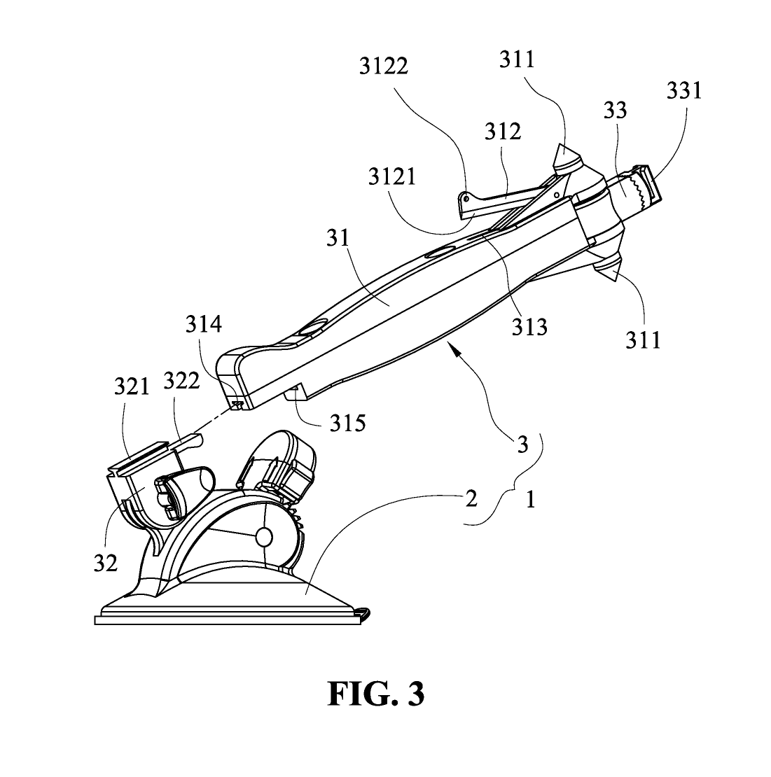

Suction disc set 2 and connecting support unit 3 are not limited to the shape and structure disclosed in the present embodiment. As long as suction disc set 2 can be attached by suction to a flat surface, the internal linkage structure is not restricted to any specific type. Connecting support unit 3 is a connecting frame with a plurality of joints for adjustment the location and angle. Connecting support unit 3 can be implemented with many available models in the market. The present embodiment shows an illustrative exemplar, but not for restrictive purpose. As shown in FIG. 2 and FIG. 3, connecting support unit 3 includes a frame 31, a coupling element 32 and an engaging element 33, located on each end of frame 31 respectively. Connecting support unit 3 uses coupling element 32 to couple suction disc set 2 and for adjusting the relative position and angle between frame 31 and suction disc set 2. The tip of engaging element 33 is a T-shape buckle piece 331 for providing engagement to holding base 4. The connection between engaging element 33 and frame 31 is not fixed, and engaging element 33 can rotate for angle adjustment of holding base 4 when engaged to engaging element 33. Although the present embodiment shows a dual-joint structure of connecting support unit 3, other equivalent structure can also be used.

Special structures are added to frame 31 of connecting support unit 3 for improvement. As shown in FIG. 3, at least a conic body 311 is formed on frame 31 close to the location connected to engaging element 33. The present embodiment shows two conic bodies 311, and placed back-to-back on frame 31. Conic boy 311 is made of solid metal. Conic body 311 can also be of other shape as long as a sharp tip is included in the stricture. For example, a pyramid, or a base with cross-section shape of a pentagon or hexagon, and so on. Also, the blade of knife 312 on frame 31 can be partially visible or entirely hidden inside frame 31. If partially visible, a preferable embodiment is to expose only a very small part, such as a tip for safety reason. In the present embodiment, the blade is entirely concealed inside frame 31. One end of knife 312 is coupled to the inside of a housing trench 313 on frame 31. When opened, only a small tip of blade 3121 is pulled to exposure to cut off the seat belt when necessary. In normal use, blade 3121 is concealed inside frame 31, as shown in FIG. 1. The back of knife 312 includes a handle block 3122, convenient for pull knife 312 out. When concealed inside frame 31, handle block 3122 protrudes above the surface of frame 31.

To enable further convenience, a detachable connection structure is used between frame 31 and coupling element 32 so that the driver can hold frame 31 by hand and hit the glass with conic body 311 after detaching frame 31 from coupling element 32. The detachable connection structure can be embodied in a plurality of manners. The present embodiment shows a structure of forming a stuck trench 314 on frame 31 having the shape of wider at the trench bottom and narrower at the trench open. The cross-sectional view of stuck trench 314 shows a T-shape. A positioning trench 315 with more depth is further included inside stuck trench 314. The corresponding locations on coupling element 32 include a stuck piece 321 and a positioning piece 322, respectively. Stuck piece 321 has the shape matching stuck trench 314, and the location of positioning piece 322 corresponds to positioning trench 315. In normal use, coupling element 32 uses stuck piece 321 to insert into stuck trench 314 of frame 31, and uses positioning piece 322 to insert into positioning trench 315 to fasten the position. When in emergency, frame 31 can be quickly removed from coupling element 32.

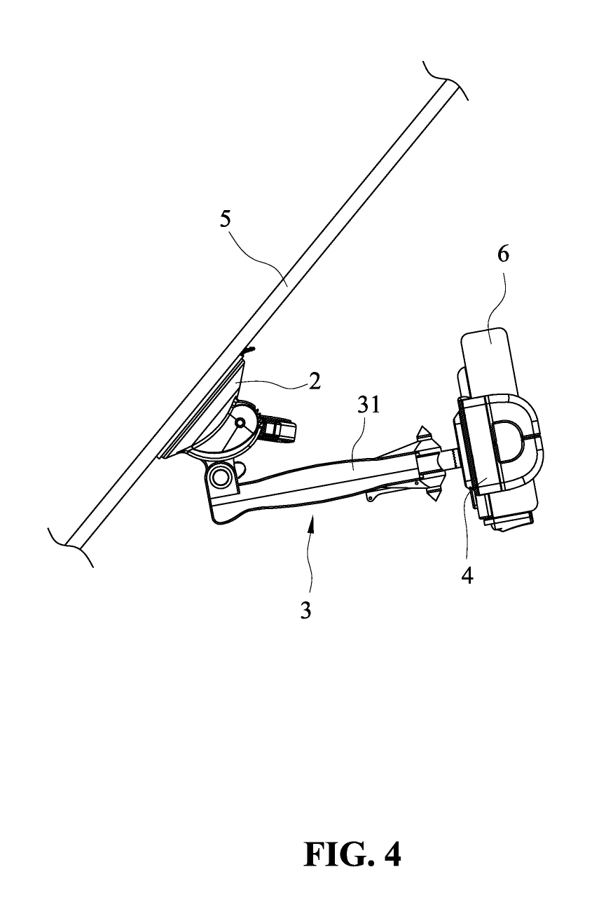

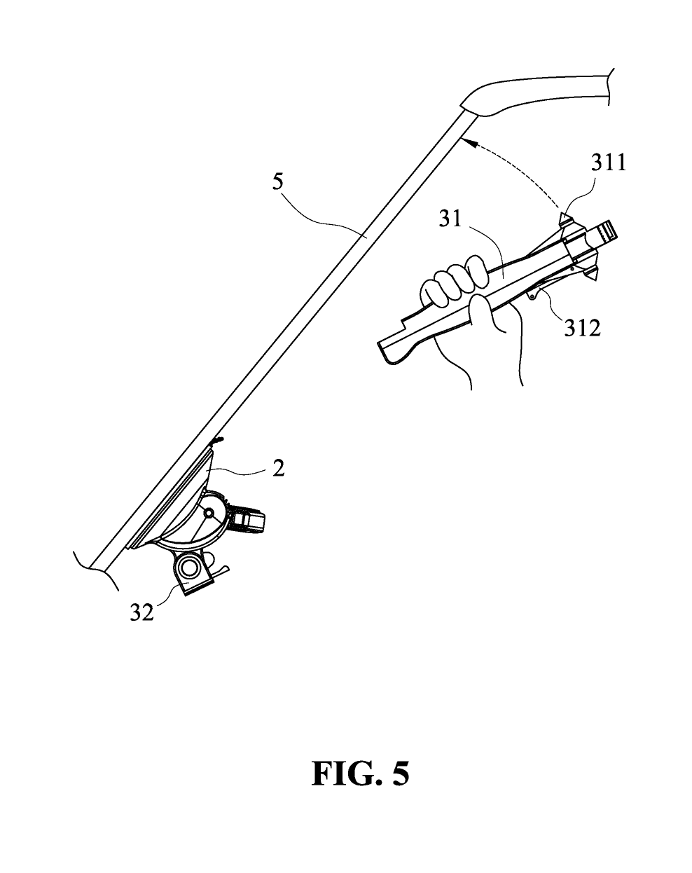

FIG. 4 shows the hand-free apparatus in actual application. The hand-free apparatus uses suction disc set 2 to attach by suction to windshield 5, and allows adjustment of position and angle of holding base 4 by connecting support unit 3 to provide the optimal viewing for the driver. As shown in FIG. 5, when in emergency, frame 31 of connecting support unit 3 is disengaged from holding base 4 and suction disc set 2. The driver can hold the frame 31 by hand and hit the corner areas of windshield 5 with conic body 311 to break the tampered glass to assist the driver from escape. In addition, if the seat belt is stuck, knife 312 can be used to cut off the seat belt.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A suction disc support set with auxiliary tool for emergency escape, comprising a suction disc set and a connecting support unit; said suction disc set able to attach by suction to a flat surface, and one end of said suction disc set coupled to said suction disc set and the other end providing engagement to a holding base, said holding base able to hold a portable device, said connecting support unit having a frame, and at least a sharp and hard conic body being formed on said frame.

2. The suction disc support set as claimed in claim 1, wherein said frame further comprises a knife.

3. The suction disc support set as claimed in claim 1, wherein said conic body is made of solid hard material, with the shape of one of round cone or multi-edge cone.

4. The suction disc support set as claimed in claim 3, wherein said multi-edge cone is one of a pyramid, a pentagon cone or a hexagon cone.

5. The suction disc support set as claimed in claim 1, wherein said connecting support unit further comprises a frame, a coupling element and an engaging element, said coupling element and said engaging element are located on two ends of said frame respectively, said frame uses said coupling element to couple with said suction disc, and a detachable connection structure is used to connect said coupling element and said frame.
